(19) United States
(12) Patent Application Publication
(10) Pub. No.: US 2006/0244173 A1
(43) Pub. Date: Nov. 2, 2006

(54) Method for making a ceramic article and ceramic extrudate

(75) Inventors: Robin Crawford, Caledonia (CA); John Shultis, Rockwood (CA); Brad Cobbledick, Waterdown (CA)

Correspondence Address: LARSON NEWMAN ABEL;POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 11/120,320

(22) Filed: May 2, 2005

(51) Int. Cl. B29C 47/00; B28B 1/00; B28B 3/20; B29C 47/12; C04B 33/32

(52) U.S. Cl. 264/176.1; 264/639; 264/177.1

(57) ABSTRACT

A method is provided for making a ceramic article. The method includes, forming an extrudate by extrusion of a moist ceramic powder body through a die, the moist ceramic powder body being shaped into a helix during extrusion, providing a pattern of surface features on the extrudate, and firing the extrudate to form a fired ceramic article.

### CROSS-REFERENCE TO RELATED APPLICATION(S)

### BACKGROUND

1. Field of the Disclosure

The following is directed generally toward ceramic articles. Particularly, the following is directed towards extruded ceramic articles which may find use in burner applications

2. Description of the Related Art

Ceramics are a robust material capable of various applications, for example, superconductors, semiconductors, abrasives, cookware, and electrical and thermal insulators. Superconducting and semiconducting ceramics are modem ceramic materials characterized by their unique electrical properties and involved processing requirements. Traditional ceramics, such as insulating ceramics, are generally characterized by strong and brittle fired bodies capable of thermal and electrical insulating properties far superior to metals or polymers. Traditional ceramics comprise a mixture of inorganic materials that, upon firing, creates a chemically inert and stable body, making traditional ceramics resilient to oxidation and other environmental effects that plague polymers and metals.

Traditional ceramics are characterized by more traditional forming methods such as slip casting, screening, pressing, molding and extrusion. All of these traditional processes make use of a ceramic slurry or moist ceramic powder body, which is created by mixing ceramic powder in a solvent such as water. The density of the slurry is controlled and altered depending upon the processing demands of the desired processing method. However, all of these processes have in common the fact that a green, or unfired, ceramic body is created. Furthermore, traditional ceramics share the common processing requirement of sintering, or a final firing, in which the green or unfired ceramic is solidified in a high temperature and long dwelling, firing process. The sintering process creates the traditional ceramic characteristics of brittleness and heat resistance.

Because of the heat resistant nature of traditional ceramic bodies they are used in a variety of applications such as electrical insulators, thermal insulators, cookware, and coatings for metals. However, because of the brittle nature of the sintered traditional ceramic material, post processing mechanical alterations and manipulations of the ceramic body are very limited. A sintered ceramic cannot be subject to high, post-firing strains, otherwise the entire ceramic pieces will fail. For example, while a sheet of metal after it has been formed may be punctured and manipulated to fit a specific application, ceramics are generally manipulated in the green state. This drawback has limited the use of traditional ceramics in creating, for example, a more efficient burner.

Burners are used in a variety of commercial and residential applications. The applications range from uses in the kitchen, to heating or boiling water, to boiling oils in deep fat fryers, to melting metals and glass in commercial applications. Prior art burners are characterized by a transport tube or diffuser tube for transporting and delivering the gas to the combustion zone. The blocks are characterized by a number of holes or pores along their length allowing the gas to escape the block and combust on the surface of the block emitting thermal radiation. Burners are comprised of high-temperature metals or ceramics or a combination of the two, to withstand the heat that is generated on the surface of the burner.

Particularly, burners made of metal are desirable because the pattern of holes or orifices in the transport tube are easily made for uniform size and spacing. The pattern of the holes is generally important because it determines the way in which the gas is delivered to the combustion zone; the more uniform the pattern of holes, the more uniform the thermal radiation that is created by the burner. In some configurations, a burner will consist of multiple metal tubes, inside one another, each tube having a unique or different pattern of holes. Often, the inner most steel tube, the diffuser, has a few large holes along its length in order to effectively mix air and gas and diffuse the mixture into an outer or secondary steel tube encompassing the diffuser. The outer, steel tube encompassing the diffuser may have a greater number of holes, those holes having a smaller cross section than the holes in the diffuser, to further mix and diffuse the mixture of gas and air effectively. The drawback with metal burners is that they are typically incapable of withstanding high temperatures and are susceptible to corrosion.

Alternatively, ceramic burners consist of at least one layer of porous ceramic such as a reticulated ceramic. Ceramic burners are typically coupled with the metal burners in a configuration where the ceramic layer is the outer most layer, and acts as a high temperature and corrosion resistant sheath for the burner. However, a problem with such burners is that given the nature of producing reticulated ceramics through a foam loss process or weaving of ceramic fibers to create a high-porosity structure, the consistency and uniformity of pore size are lost or at least difficult to control. Reticulated ceramics are generally made through a foam loss process whereby a high porosity foam is covered in a ceramic slurry and upon firing of the ceramic and foam, the foam is burned off, or lost. The remaining reticulated ceramic is a high porosity structure, but the consistency and uniformity of the pores is poor. The same problem exists for weaving of fibers of SiC or SiN. The entanglement of the fibers creates a high porosity ceramic, but the consistency and uniformity of the pores is poor. The inconsistent pore size and spacing makes for inefficient and unequal distribution of infrared radiation and makes the burner less efficient. Furthermore, the attachment of the ceramic sheath to the stainless tubes is difficult.

The industry continues to demand ceramic components having novel structures and novel techniques for fabrication. The burner industry in particular demands high temperature ceramic burners for use in broad range of applications.

### SUMMARY

According to one aspect a method of providing infrared radiation is described. The method comprises delivering a combustible gas into a ceramic tube having a pattern of perforations extending through a thickness of the ceramic tube and igniting the combustible gas flowing through the pattern of perforations.

Another aspect provides a method of making a ceramic article. The method including forming an extrudate by extrusion of a moist ceramic powder through a die, the moist ceramic powder being shaped into a helix during extrusion, and providing a pattern of surface features on the extrudate. The method also includes firing the extrudate to form a fired ceramic article.

### BRIEF DESCRIPTION OF THE DRAWINGS

The present disclosure may be better understood, and its numerous features and advantages made apparent to those skilled in the art by referencing the accompanying drawings.

FIG. 1 is an illustration of a tube comprised of helical windings.

FIG. 2A is an illustration of helical windings being perforated and forming a tube.

FIG. 2B is an illustration of a pattern of perforations.

FIG. 2C is an illustration of an array of perforations.

FIG. 3 is an illustration of a diffuser tube inside a perforated ceramic tube.

FIG. 4 is an illustration of a perforation having a cylindrical contour.

FIG. 5 is an illustration of a perforation having a tapered contour.

FIG. 6 is an illustration of a perforation having a partially tapered contour.

FIG. 7 is an illustration of a tube having a tapered contour.

FIG. 8 is an illustration of a tube having more than one tapered contour.

FIG. 9A is an illustration of a rotating auger, die, rotating extrudate and jig configuration.

FIG. 9B is an illustration of a die opening having an annular contour.

FIG. 9C is an illustration of a die opening having a rectangular contour.

The use of the same reference symbols in different drawings indicates similar or identical items.

### DESCRIPTION OF THE PREFERRED EMBODIMENT(S)

FIG. 1 illustrates a ceramic tube 100 comprised of helical windings 102. In one particular embodiment, the tube is formed by winding a ceramic tape formed of the helical windings 102. The ceramic tape may be formed by extrusion, however, as discussed previously there are many other methods of forming ceramic tape such as, casting, molding or deposition. In other embodiments, discussed in more detail below, the ceramic tube 100 is formed by a direct extrusion process in which the extrudate assumes the form of a tube, in which helical windings are joined together prior to exit from the die. Extrusion offers an advantage of a continuous processing that provides an extrudate with a desirable green strength and flexibility to undergo further manipulation, such as surface texturing of the extrudate and/or winding of the tape into a helix. The extruded ceramic body is a clay body or a ceramic powder body having the consistency of a moist ceramic powder with some plastic characteristics. In one embodiment, the moisture content of the ceramic powder body is in a range of about 5% to 30% by weight. In other embodiments, the moisture content of the ceramic powder body is in a range of about 10% to 15% by weight and as such, in a range of about 15% to 17% by weight.

In the case of tape extrusion, after forming the ceramic tape, the tape is wound to form an extruded helical tape having helical windings 102. The helical windings 102 are collected, compressed and the adjacent windings are joined to form a tube. The green ceramic tube is then fired to form a sintered helical tape, which forms the sintered ceramic tube. As is understood in the art, firing of ceramics involves sintering the ceramic body, which typically involves holding the ceramic at high temperatures for a long duration to solidify and strengthen the body.

Suitable ceramic materials are selected that will yield a body capable of forming an extrudate as well as a final sintered piece that has resilience to high temperatures. According to one embodiment, it is preferable that the ceramic body withstands the processing requirements of extrusion. As such, the final sintered ceramic will generally contain not less than about 85% ceramic by weight, while in other embodiments the final sintered ceramic will contain not less than about 95% ceramics by weight. A wide range of ceramics is available which generally includes materials such as oxides, nitrides and carbides, or combinations of these materials. For example, a body may contain oxides, such as SiO₂, Al₂O₃, CaO, Na₂O, MgO, Fe₂O₃, TiO₂, K₂O, MnO, P₂O₅, Cr₂O₃, and ZrO₂, in various proportions. As is understood in the art, the ceramic body may make use of higher percentages of SiO₂ and Al₂O₃, in comparison to other oxides, because these ceramic compounds are the basis for stable ceramic bodies. In comparison, the other oxides may be used to a lesser degree as fillers or fluxes. Other embodiments may make use of SiC or SiN.

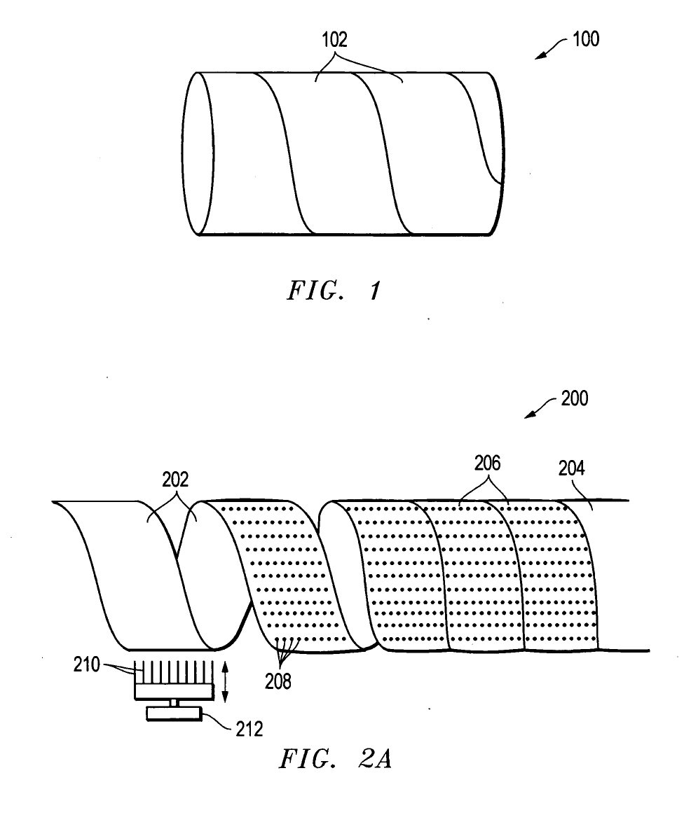

According to the embodiment shown in FIG. 2A, a tape 200 is extruded and gathered on a shaft 204. The tape 200 is wound around the shaft 204 to form a helix having adjacent windings 202. After sufficient windings have been gathered on the shaft, the adjacent windings 202 are joined to form a tube 206 or hollow cylinder from a single layer of windings. The windings can be joined using a variety of techniques. For example, one embodiment demonstrates wetting the windings and compressing the windings to join the single layer of adjacent windings to form the tube 206. Another embodiment contemplates the use of lap joints, wherein the edges of the adjacent windings overlap to form a tube. In this regard, the lap joints may be formed during sintering processing, such that natural shrinkage and densification of the extrudate forces the windings together. The adjacent windings are solidified and strengthened in the sintering process. Other embodiments show the windings joined during the extrusion process. In the embodiment shown in FIG. 2A, the windings are joined post-extrusion. In contrast, as already noted above, the windings may be jointed in situ, in the die prior to exit, such that the as-formed extrudate is a tube rather than a tape.

The tube wall thickness is determined in part by the die opening. The tube wall thickness is defined as the difference between the inner radius of the tube wall and the outer radius of the tube wall. In one embodiment, the tube wall thickness is not less than about 5 millimeters, such as not less than 10 millimeters, and still, in other embodiments, the tube wall thickness is not less than 20 millimeters. For example, in one embodiment, the tube wall thickness is approximately 25 millimeters.

In one embodiment, post extrusion processing of the extrudate includes providing surface features on the ceramic tape. For example, in FIG. 2A the surface features are a pattern of perforations 208 that are spread apart from each other along the circumferential and longitudinal directions. The pattern of perforations 208 extend through an entirety of a thickness of the extrudate and provide 360 degrees of coverage. The perforations may be provided in a variety of ways. For example, FIG. 2A demonstrates providing the perforations using an array of reciprocating pins 210. In the embodiment, the array of reciprocating pins 210 is connected to a motor 212, capable of translating the array of reciprocating pins 210 in one direction. The pins translate in one direction and perforate the extrudate through the thickness of the extrudate. In one embodiment, the array of reciprocating pins 210 perforate the extrudate in the form of a tape as it exits the extruder, but before helical windings or a tube is formed. Other embodiments contemplate perforating the tape after the helical tape 202 forms the windings, as shown in FIG. 2A, while other embodiments perforate an extrudate in the form of a rotating ceramic tube emerging from the die. Still other embodiments utilize multiple arrays of reciprocating pins, or an array of reciprocating pins that can translated in various planes, whereby the pins are rotated about the helical windings.

The embodiment illustrated in FIG. 2A utilizes an array of pins to provide a pattern of perforations 208. As used herein, the term ‘pattern’ is defined as a repeatable unit of perforations. For example, FIG. 2B illustrates a pattern, having a repeatable unit of four perforations 260. However, the embodiment illustrated in FIG. 2A also contemplates an array of pins capable of providing an array of perforations 208. As defined herein, an ‘array’ is a species of a pattern, and denotes a two-dimensional grid of perforations having generally uniform spacing, and typically uniform shape and size. An array of perforations is illustrated in FIG. 2C in which each perforation is approximately an equal distance and orientation from any other perforation.

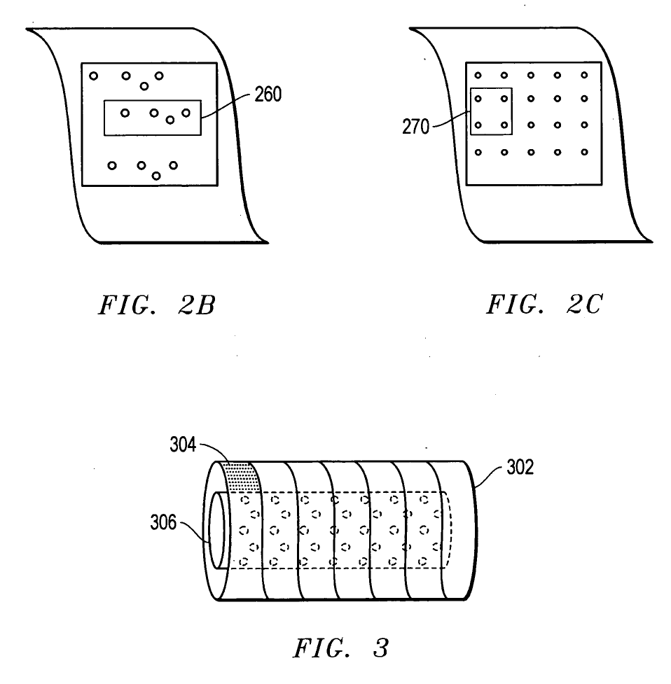

As previously discussed, in some applications such as burner components, there is a need for high temperature, high void area ceramics. More particularly, there is a need for high temperature ceramics manufactured with controlled uniformity of open porosity, because the uniformity of the pores corresponds to uniform gas flow from the burner component, and accordingly, uniform and efficient burner operation. In one embodiment, illustrated in FIG. 3, a burner component or burner sheath 302 is overlying a transport tube 306. The transport tube 306 is typically metal and delivers the combustible gas to the burner sheath 302. The transport tube 306 typically has an open first end for receiving the gas, a closed second end, and a plurality of holes along its length through which the combustible gas flows. The transport tube 306 has larger but fewer holes than the burner sheath 302. The gas flows through the plurality of holes in the transport tube 306 and is delivered into the burner sheath 302. The gas flows through the pattern of perforations in the burner sheath 302 and is ignited by an igniter on the surface of the burner sheath 302.

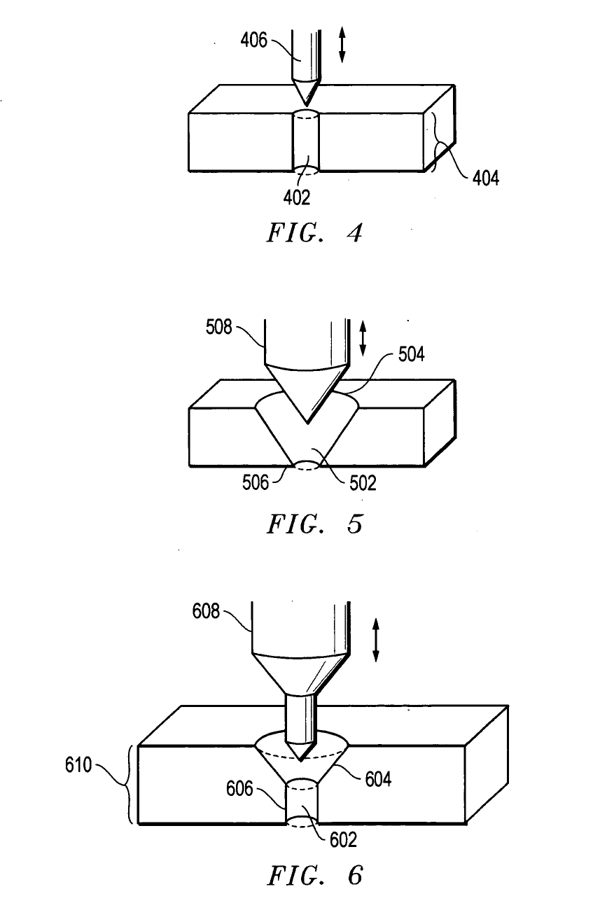

The open porosity in the form of through holes or perforations is controlled not only in terms of the uniformity of the spaces between the perforations but in the shape and size of the perforations as well. FIGS. 4-6, illustrate perforation shapes. To use the previous example, according to certain embodiments, burner components and burner sheaths not only have uniformity of open pore spacing, but uniformity of pore size and shape. The array of reciprocating pins 210 may be modified to determine the size and shape of the perforations. For example, in FIG. 4, the perforation 402 is shown as having a cylindrical contour through the thickness of the extrudate 404. The cylindrical pin 406 perforates, extending through the thickness of the extrudate 404 to form a perforation 402 having a cylindrical contour. The diameter of the perforation is approximately the same as the diameter of the cylindrical pin 406.

Another embodiment, as illustrated in FIG. 5, illustrates a tapered perforation 502 having a tapered contour. Tapered perforations can vary, in the degree to which the hole is tapered, as well as the direction in which the tapered contour extends. In burner components, a tapered perforation produces a pressure drop across the thickness of the tube, forcing the gas out of the tube and through the hole while distributing the gas across a wider surface at the outer surface of the extrudate, where the gas is ignited. As shown in FIG. 5, typically the tapered perforation 502 has a greater cross sectional area at the outer surface of the extrudate 504 than the cross sectional area of the perforation at the inner surface 506. The tapered perforation 502 is made using a pin 508 having a tapered head that perforates the thickness of the extrudate 510.

Yet another embodiment, illustrated in FIG. 6, shows a partially tapered perforation 602, wherein the tapered contour of the perforation 604 extends only partially through the thickness of the extrudate, and the remaining portion of the perforation extends having a cylindrical contour 606. The partially tapered pin 608 perforates the thickness of the extrudate 610 to make the perforation 602 having the combination of the tapered contour 604 and the cylindrical contour 606. Other perforations having unique contours are contemplated but not illustrated.

Further, according to embodiments herein, the open surface area as a result of the perforations on the surface of the ceramic tube, is variable. The term ‘open surface area’ is herein defined as the percentage of surface area of the ceramic tube that is consumed by the perforations. For example, the open surface area for a tube as described previously is calculated as the total surface area of the perforations divided by the total surface area of the outer surface of the tube without the perforations. In applications such as burner sheaths, the open surface area is related to the rate at which the gas burns and the amount of heat that is emitted on the surface area of the ceramic tube. According to one embodiment, the open surface area on the surface of the ceramic tube is not less than about 20%, such as not less than about 35%. In various embodiments, the open surface area is not greater than about 50%.

The open surface area may be varied by manipulating the number of perforations per unit of area or the size of the perforations. The number of perforations per unit of area is determined by the number of reciprocating pins in the array of reciprocating pins and/or the speed of extrusion. The size of the perforations is determined by the diameter of each pin in the array of reciprocating pins. In the instance of burner components, generally the larger the diameter of the ceramic tube required, the larger the diameter of the perforations necessary to accommodate the increased gas pressure. However, it is recognized that the size of the perforations depends in part upon the application and the size of the perforations may be determined based upon the gas velocity and flame velocity dynamic. Moreover, the larger the diameter of the burner component required, the thicker the extrudate and the thicker the tube wall. A thicker tube wall may require a larger diameter pin to effectively perforate through the proportionally thicker extrudate. According to embodiments herein, the diameter of the perforations created by the array of reciprocating pins is not less than about 0.025 centimeters, such as not less than about 0.050 centimeters, or even not less than about 0.10 centimeters. The diameter of the perforations is typically not greater than about 0.25 centimeters.

The shape of the tube is variable in order to accommodate a variety of applications. The tube as shown in FIGS. 1 and 2 is a hollow cylinder, but other embodiments are contemplated. A cylindrical tube provides a common shape and sufficient surface area to be used in a variety of applications. For example, in the case of burners, cylindrical tubes or housings are common because the gas is easily and evenly distributed through the symmetry of the tube, making the radiation emitted by the burner uniform, making the burner efficient. Moreover, a cylindrical tube is compatible with a variety of metal transport tubes for burner applications, as illustrated in FIG. 3.

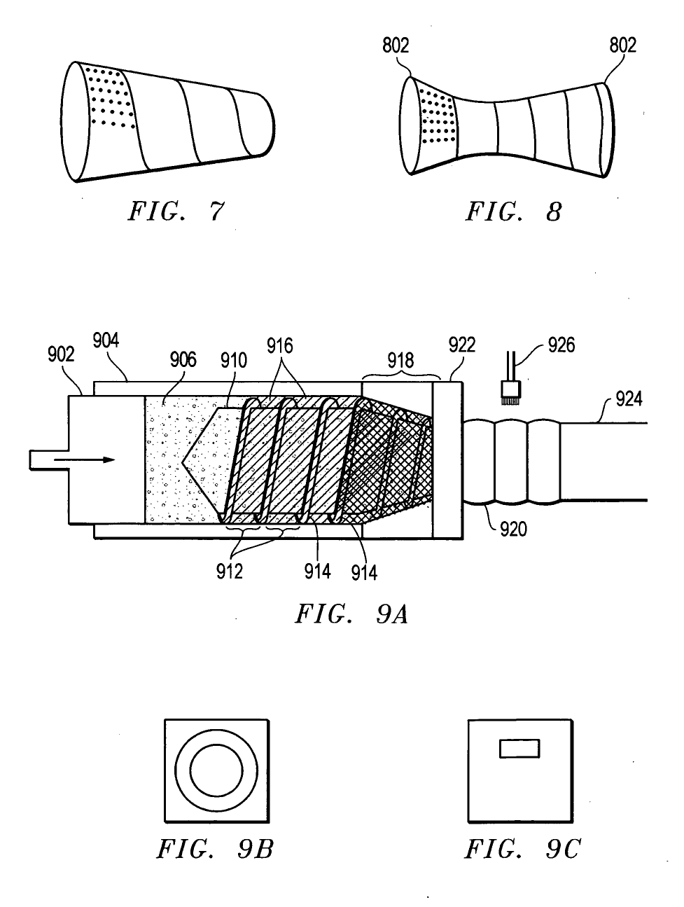

In other embodiments, as shown in FIGS. 7 and 8, the tube has a tapered shape. FIG. 7 illustrates that the tube may be tapered in one direction to form a conical contour, wherein the diameter of the tube decreases at a generally constant rate along the length of the tube. In another embodiment, as illustrated in FIG. 8 the contour of the tube is more complex, having a bi-conical tapered shape such that the diameter of the tube expands from an interior, smallest diameter portion. The tapered tube in this embodiment has flanges 802 at opposite ends of the tube and is constricted between the flared ends. Other embodiments are contemplated, for example, closing one end or both ends of the cylinder in a variety of ways, depending upon the anticipated final application of the tube.

FIG. 9A illustrates a generalized setup of an extrusion apparatus for extruding tapes and tubes. A die punch 902 is positioned at the open end of the extrusion barrel 904 to force the ceramic powder body 906 into helical channels die 912. Alternatively, the die punch 902 can be an auger or any mechanism used to advance the ceramic powder body 906 into the helical channels 912. The helical channels 912 are defined by an inner barrel 910 housed within the extrusion barrel 904, and a spiraling divider 914 spaced circumferentially between the extrusion barrel 910 and inner barrel 910 and spiraling around the inner barrel 910. The ceramic powder body 906 is forced into the helical channels 912 and is formed into a helical-shaped ceramic powder body 916. The helical-shaped ceramic powder body 916 moves through the helical channels 912 to a die exit region 918. The die exit region 918 is positioned at the opposite end of the extrusion barrel 904 from the die punch 902 and is defined by a circumferentially tapered contour for constricting the helical-shaped ceramic powder body 916 exiting the helical channels 912. In one embodiment, the circumferentially tapered contour of the die exit region 918, illustrated in FIG. 9, compresses the windings of the helical-shaped ceramic powder body 916 so that the adjacent windings are joined and a hollow tube 920 is formed prior to exit from the die exit region 918.

In one embodiment, the hollow tube 920 is extruded through a die opening 922 positioned at the exit end of the extrusion barrel 904. The hollow tube 920 rotates during extrusion and exits from the die exit region 918, through the die opening 922 and is gathered on a shaft 924. Rotation of the hollow tube 910 along the shaft 924 enables formation of a pattern of surface features, such as perforations, using a fixed position perforation mechanism, such as an array of pins 926 as discussed above. More specifically, the array of pins 926 as shown in the embodiment, perforate the hollow tube 920 as it rotates and exits through the die opening 922. In this embodiment the ceramic tube extrudate 910 is gathered on the shaft 912 and is not extruded as a tape that requires winding. In addition, extrusion of an as-formed tube from internally joined helical windings may ease mechanical strains in the extrudate, as compared to embodiments relying on tape extrusion. Further, the circumferentially tapered contour of the die exit region 918 allows for continuous processing without need for winding a tape. The embodiment shows a continuous process that improves throughput.

The shape of the extruded ceramic powder body is determined in part, by the contour of the die opening 922. FIGS. 9B and 9C illustrate two embodiments of die opening contours. FIG. 9B is a die opening having an annular contour. The annular contour of the die opening defines an extrudate with an annular cross section. According to one embodiment, as previously discussed, the annular contour of the die opening 922 allows the helical-shaped ceramic powder body 916 to be extruded as a hollow tube 920 upon exit from the extruder.

FIG. 9C is a die opening having a rectangular contour. According to one embodiment, the die opening may have a polygonal contour, while other embodiments contemplate a die opening having the contour of a parallelogram. The die opening having a rectangular contour, as illustrated in FIG. 9C, allows the extrudate to form a tape, which can form a helical tape having windings. In one embodiment the tape is gathered on a jig, while other embodiments make use of a shaft and the tape is wound around the shaft to form helical windings. Some embodiments make use of both the shaft and a jig. As discussed previously, the windings may be joined in the green state or during firing. Still, in another embodiment the windings may not be joined and remain spaced apart from each other forming gaps between the windings.

The die opening 908 defines in part, the cross sectional contour of the extrudate. For example, the die opening having a rectangular contour, illustrated in FIG. 9C, can be described by a dimension ratio of the die opening measurements. The dimension ratio of the die opening is a ratio between the measurement of the width and the thickness. In one embodiment, the die opening has a dimension ratio of not less than about five to one, where the width is five times the measurement of the thickness. Still, in another embodiment the dimension ration is not less than about ten to one, where the width is ten times the measurement of the thickness.

While particular aspects of the present invention have been described herein with particularity it is well understood that those of ordinary skill in the art may make modifications hereto yet still be within the scope of the present claims. The previously mentioned embodiments and examples, in no way limit the scope of the following claims.

1-4. (canceled)

5. A method of making a ceramic article comprising:
forming an extrudate by extrusion of a moist ceramic powder body through a die, the moist ceramic powder body being shaped into a helix during extrusion;
providing a pattern of surface features on the extrudate; and
firing the extrudate to form a fired ceramic article.

6. The method of claim 5, wherein the extrudate is in the form of a helix comprising windings.

7. The method of claim 6, wherein the die includes a die opening through which the extudate exits the die, the die opening having a polygonal contour which shapes the extrudate to form a helix comprising windings.

8. (canceled)

9. The method of claim 7, wherein the die opening has a rectangular contour which shapes the extrudate to form a helix comprising windings.

10. The method of claim 9, wherein the die opening has a dimension ratio of not less than about 5 to 1, the width being five times the measurement of the thickness, defining an extrudate having a substantially similar dimension ratio.

11. (canceled)

12. The method of claim 6, wherein the windings are joined in a green state.

13-15. (canceled)

16. The method of claim 6, wherein the windings remain spaced apart from each other forming gaps between windings.

17. The method of claim 5, wherein the moist ceramic powder body is shaped into the helix in the die, the helix being compressed along an exit of the die such that the extrudate forms a hollow tube.

18. The method of claim 17, wherein the die includes a die opening through which the extudate exits the die, the die opening having an annular contour which shapes the extrudate to form a hollow tube.

19. The method of claim 17, wherein the extrudate rotates along its central axis upon exit from the die.

20. The method of claim 5, wherein the surface features provide 360 degrees of coverage.

21. (canceled)

22. The method of claim 5, wherein the ceramic article comprises not less than 85% ceramic, by weight.

23. The method of claim 22, wherein the ceramic article is comprised of an oxide, nitride, or carbide.

24. The method of claim 23, wherein the ceramic article is comprised of an oxide.

25. The method of claim 24, wherein the ceramic article is comprised of at least one ceramic material selected from the group consisting of SiO₂, Al₂O₃, Na₂O, MgO, Fe₂O₃, TiO₂, K₂O, MnO, P₂O₅, Cr₂O₃, and ZrO₂ and combinations thereof.

26. (canceled)

27. (canceled)

28. The method of claim 5, wherein providing a pattern of surface features on the tape includes providing a pattern of perforations on the tape.

29. (canceled)

30. The method of claim 28, wherein providing a pattern of perforations on the tape includes perforating the tape with reciprocating pins.

31-32. (canceled)

33. The method of claim 28, wherein providing a pattern of perforations on the tape includes perforations, each perforation having a diameter not less than about 0.025 centimeters and not greater than about 0.25 centimeters.

34. The method of claim 33, wherein the pattern of perforations on the tape includes perforations, each perforation having a diameter not less than about 0.05 centimeters and not greater than about 0.20 centimeters.

35-36. (canceled)

37. The method of claim 28, wherein providing a pattern of perforations on the windings defines an open surface area on the surface of the windings not greater than about 50%.

38. The method of claim 37, wherein providing a pattern of perforations on the windings defines an open surface area on the surface of the winding not less than about 20%.

39. The method of claim 5, wherein extruding a moist ceramic powder body to form a helix comprising windings includes gathering the extrudate on a jig.

40. The method of claim 39, wherein gathering the extrudate on a jig includes winding the tape around a shaft such that the tape forms a helix having windings.
